(19) United States
(12) Patent Application Publication
(10) Pub. No.: US 2022/0183410 A1
(43) Pub. Date: Jun. 16, 2022

(54) DETACHABLE PICTURE ATTIRE

(71) Applicant: Danielle Grimes, San Diego, CA (US)

(72) Inventor: Danielle Grimes, San Diego, CA (US)

(21) Appl. No.: 17/120,188

(22) Filed: Dec. 13, 2020

(51) Int. Cl. A41D 27/08

(52) U.S. Cl. CPC A41D 27/08

(57) ABSTRACT

An article of manufacture for providing clothing with detachable hand-painted pictures is disclosed. The article includes an article of clothing having an attachment location, a removable picture having a size and shape matching the attachment location, a plurality of attachment devices coupled to the article of clothing about the attachment location, and a plurality of mating attachment devices coupled to the removable picture about its outer edges.

### TECHNICAL FIELD

This application relates in general to an article of manufacture providing wearable art, and more specifically, to an article of manufacture providing clothing with detachable pictures.

### BACKGROUND

Men and women are willing to spend large sums of money to acquire clothing, such as outerwear, that includes hand-painted artwork displayed on the item of clothing. For example, hand-painted images are painted on the backs of jackets as part of their designs. These jackets may have a base color for the fabric that the individual may wish to come in a different color depending upon the situation. Alternatively, an individual may invest in multiple paintings that they want to find a way where they could have one jacket and multiple pictures. Obtaining multiple versions of a picture on more than one item of clothing would be prohibitively expensive for most individuals. Most individuals may desire to not buy multiple $100 dollar jackets to get different images to go with an outfit.

Therefore, a need exists for an article of manufacture for providing clothing with detachable pictures. The present invention attempts to address the limitations and deficiencies in prior solutions according to the principles and example embodiments disclosed herein.

### SUMMARY

In accordance with the present invention, the above and other problems are solved by providing an article of manufacture for clothing with detachable pictures according to the principles and example embodiments disclosed herein.

In one embodiment, the present invention is an article of manufacture for providing clothing with detachable pictures. The article includes an article of clothing having an attachment location, a removable picture having a size and shape matching the attachment location, a plurality of attachment devices coupled to the article of clothing about the attachment location, and a plurality of mating attachment devices coupled to the removable picture about its outer edges.

The foregoing has outlined rather broadly the features and technical advantages of the present invention in order that the detailed description of the invention that follows may be better understood. Additional features and advantages of the invention will be described hereinafter that form the subject of the claims of the invention.

It should be appreciated by those skilled in the art that the conception and specific embodiment disclosed may be readily utilized as a basis for modifying or designing other structures for carrying out the same purposes of the present invention. It should also be realized by those skilled in the art that such equivalent constructions do not depart from the spirit and scope of the invention as set forth in the appended claims. The novel features that are believed to be characteristic of the invention, both as to its organization and method of operation, together with further objects and advantages will be better understood from the following description when considered in connection with the accompanying figures. It is to be expressly understood, however, that each of the figures is provided for the purpose of illustration and description only, and is not intended as a definition of the limits of the present invention.

### BRIEF DESCRIPTION OF THE DRAWINGS

Referring now to the drawings in which like reference numbers represent corresponding parts throughout:

FIG. 1 illustrates an example embodiment of an article of manufacture providing clothing with detachable hand-painted pictures according to the present invention.

FIG. 2 illustrates another view of an article of manufacture providing clothing with detachable hand-painted pictures according to the present invention.

FIG. 3 illustrates an example embodiment of an article of manufacture providing detachable hand-painted pictures attachable to an item of clothing according to the present invention.

FIG. 4 illustrates another view of an article of manufacture for providing clothing with detachable hand-painted pictures according to the present invention.

### DETAILED DESCRIPTION

This application relates in general to an article of manufacture for providing wearable art, and more specifically, to an article of manufacture providing clothing with detachable hand-painted pictures according to the present invention.

Various embodiments of the present invention will be described in detail with reference to the drawings, wherein like reference numerals represent like parts and assemblies throughout the several views. Reference to various embodiments does not limit the scope of the invention, which is limited only by the scope of the claims attached hereto. Additionally, any examples set forth in this specification are not intended to be limiting and merely set forth some of the many possible embodiments for the claimed invention.

In describing embodiments of the present invention, the following terminology will be used. The singular forms “a,” “an,” and “the” include plural referents unless the context clearly dictates otherwise. Thus, for example, reference to “a needle” includes reference to one or more of such needles and “etching” includes one or more of such steps. As used herein, a plurality of items, structural elements, compositional elements, and/or materials may be presented in a common list for convenience. However, these lists should be construed as though each member of the list is individually identified as a separate and unique member. Thus, no individual member of such list should be construed as a de facto equivalent of any other member of the same list solely based on their presentation in a common group without indications to the contrary. As used herein, the singular forms “a,” “an,” and “the” are intended to include the plural forms as well, unless the context clearly indicates otherwise.

It further will be understood that the terms “comprises,” “comprising,” “includes,” and “including” specify the presence of stated features, steps or components, but do not preclude the presence or addition of one or more other features, steps or components. It also should be noted that in some alternative implementations, the functions and acts noted may occur out of the order noted in the figures. For example, two figures shown in succession may in fact be executed substantially concurrently or may sometimes be executed in the reverse order, depending upon the functionality and acts involved.

The terms “customer,” and “user” refer to an entity, e.g. a human, wearing clothing with detachable hand-painted pictures associated with the invention. The term user herein refers to one or more users.

The term “invention” or “present invention” refers to the invention being applied for via the patent application with the title “Detachable Picture Attire.” Invention may be used interchangeably with wearable art.

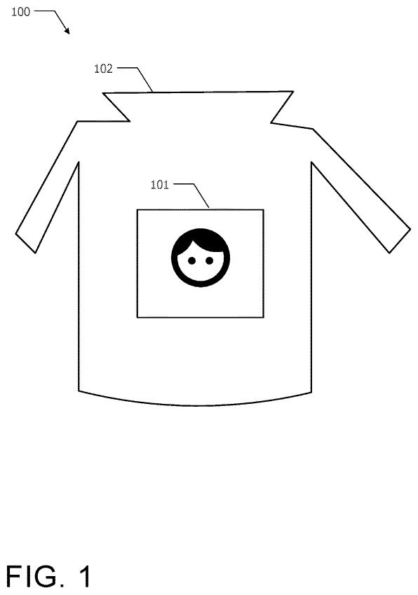

In general, the present disclosure relates to an article of manufacture for wearable picture art. To better understand the present invention, FIG. 1 illustrates an example embodiment of an article of manufacture providing clothing with detachable hand-created pictures according to the present invention. A jacket 102 is shown with a picture 101 located on the back of the outer surface of the jacket. The jacket 102 may be made in many styles, colors, sizes, and material. In addition, other items of clothing such as sweaters, shirts, blouses, sweatshirts, dresses, and the like may be utilized in place of the jacket.

The picture 101 may be of many sizes, materials, locations on the item, and types of hand-created artwork. The jacket 102 and picture 101 of FIG. 1 are meant to be an example embodiment. The hand-created picture 101 The present invention should not be limited by these details of the example embodiments and be defined solely on the limitations recited within the attached claims.

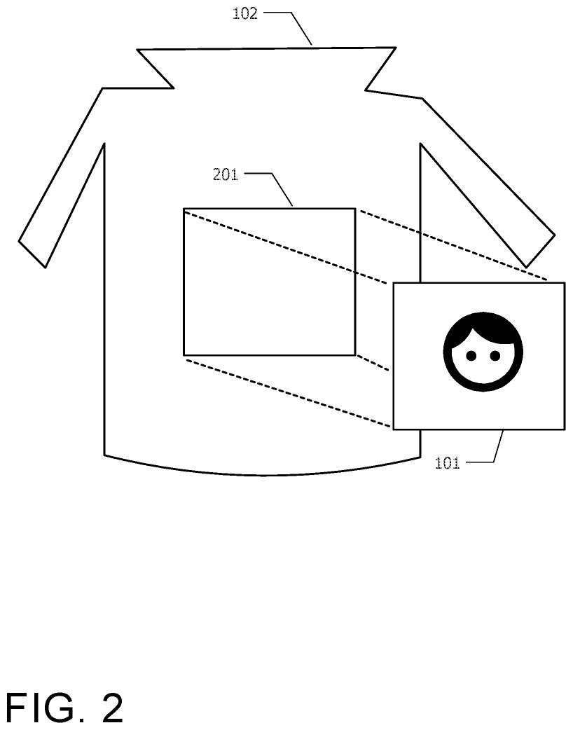

As shown in FIGS. 2-4 below, the picture 101 may be attached and removed from the jacket 101 by the user to permit one or more different pictures to be worn on an item of clothing and one picture to be worn on different items of clothing. In the example embodiment of the jacket 102, the jacket may be made of denim fabric having an attachment location (as shown in FIG. 2) in a spot where the picture 101 may be attached and removed as desired. Individual pictures 101 which may be either hand-painted or heat-pressed images, may be attached using attachment devices including zippers, buttons, snaps, Velcro™, and the like.

FIG. 2 illustrates another view of an article of manufacture for providing clothing with detachable hand-created pictures according to the present invention. The example embodiment of FIG. 2 shows the picture 101 as it has been removed from the attachment location 201 located on the back of the jacket. The jacket may possess a liner fabric covering the attachment location, may be made of the jacket base material, or may consist of a hole in the jacket's fabric. All of these example embodiments for the attachment location are covered and not seen when the picture 101 is attached. As noted above, the picture 101 may be of many different sizes and positioned at many different attachment locations 201.

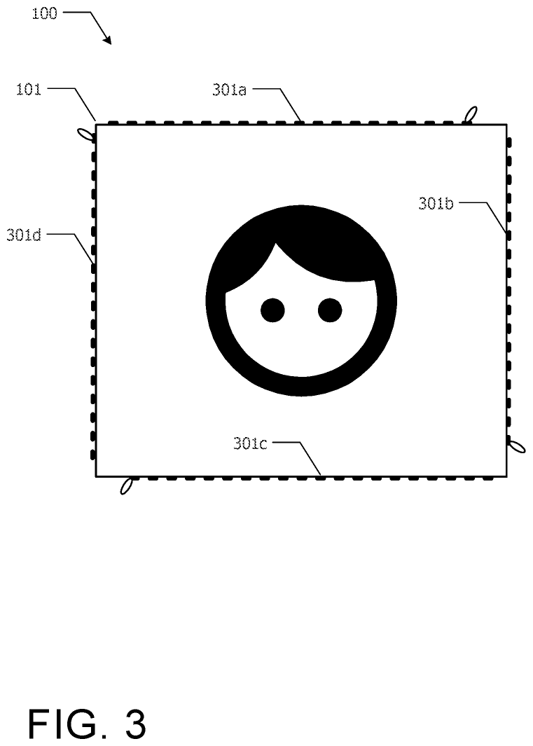

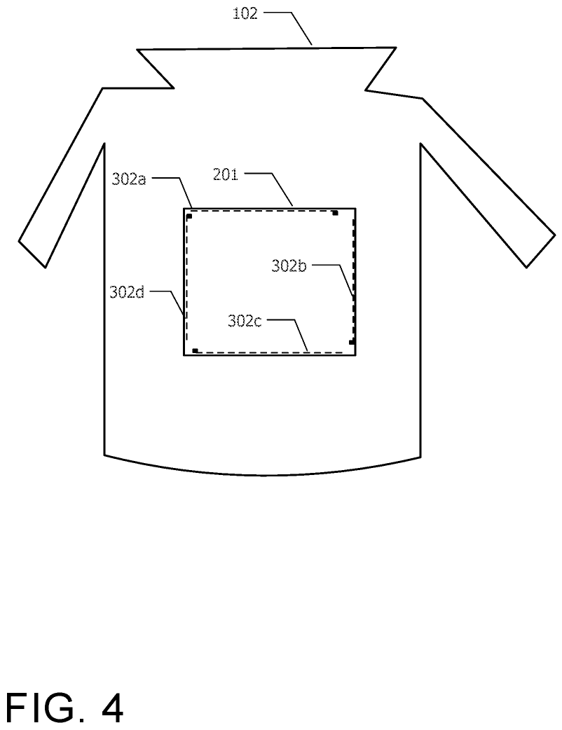

FIG. 3 illustrates an example embodiment of an article of manufacture providing a detachable hand-painted picture attachable to an item of clothing according to the present invention. The hand-created picture 101 is shown in FIG. 3 having a set of zippers 301a-d located about each of the four sides of the picture 101. This set of zippers 301a-d engage and couple to a set of mating zippers 302a-d (shown in FIG. 4) located about the attachment location 201 of a jacket 101 or other item of clothing.

The user may simply attach a particular picture 101 onto the attachment location 201 before he or she leaves wearing the jacket 102. Upon return, the picture 101 may be removed and stored for safe keeping and replaced with a different picture 101 as desired. Additionally, the picture 101 may require different cleaning methodologies than an ordinary item of clothing such as a jacket. Depending upon the method and material used in the creation of the hand-created picture 101, the jacket 101 may not be cleaned while the picture 101 is attached without potentially damaging the picture 101. As such, users may remove the picture 101, wash the jacket 102 in a usual manner for the type of jacket and its material, and then reattach the hand-created picture 101 once the jacket 102 has been cleaned.

FIG. 4 illustrates another view of an article of manufacture for providing clothing with detachable hand-created pictures according to the present invention. In the example embodiment of FIG. 4, the jacket 102 is shown with a set of mating zippers 302a-d positioned about the edges of the attachment location 201. The set of zippers 301a-d, 302a-d hold the edges of the picture 101 in place while the jacket 102 is worn. The set of zippers 301a-d, 302a-d may be positioned to be covered by a small tab of fabric (not shown) about the edges of the attachment location 201.

While the example embodiment of FIGS. 3-4 show the use of the set of zippers 301a-d, 302a-d to attach the picture 101, other attachment devices may be used. A set of buttons or snaps may be positioned about the edges of the attachment location 201 with a set of mating snaps or buttonholes being located about the rear edges of the picture 101. Additionally, a strip of Velcro™ or similar attachment material may be placed about the inner edges of the attachment location 201 with the corresponding strip of mating material positioned about the back side of the picture 101 about the edges. In each of these example embodiments, the hand-created picture 101 may be attached and removed as desired by the user by coupling the mating items of the attachment mechanisms together to place the picture 101 over the attachment location.

Even though particular combinations of features are recited in the present application, these combinations are not intended to limit the disclosure of the invention. In fact, many of these features may be combined in ways not specifically recited in this application. In other words, any of the features mentioned in this application may be included to this new invention in any combination or combinations to allow the functionality required for the desired operations.

No element, act, or instruction used in the present application should be construed as critical or essential to the invention unless explicitly described as such. Further, the phrase “based on” is intended to mean “based, at least in part, on” unless explicitly stated otherwise.

What is claimed is:

1. An article of manufacture for providing clothing with detachable pictures, the article comprises:
an article of clothing having an attachment location;
a removable picture having a size and shape matching the attachment location; and
a plurality of attachment devices coupled to the article of clothing about the attachment location; and
a plurality of mating attachment devices coupled to the removable picture about its outer edges.

2. The article of manufacture according to claim 1, wherein the removable picture comprises a hand-created artwork.

3. The article of manufacture according to claim 2, wherein the removable picture comprises a hand-painted picture.

4. The article of manufacture according to claim 2, wherein the removable picture comprises a heat pressed image.

5. The article of manufacture according to claim 1, wherein the plurality of attachment devices and the plurality mating attachment devices comprises a set of zippers located along the edges of the attachment location and the removable picture.

6. The article of manufacture according to claim 5, wherein the plurality of attachment devices and the plurality mating attachment devices further comprises a set of buttons, a set of snaps, and a strip of Velcro.

7. The article of manufacture according to claim 1, wherein the article of clothing comprises a jacket, a sweater, a shirt, a blouse, a sweatshirt, and a dress.

8. The article of manufacture according to claim 7, wherein the article of clothing may have a plurality of attachment locations for coupling to a plurality of removable pictures.

9. The article of manufacture according to claim 7, wherein plurality of attachment locations have different sizes.

10. The article of manufacture according to claim 1, wherein the attachment locations have a liner to be covered when the removable picture is attached.
